(19) United States
(12) Patent Application Publication
(10) Pub. No.: US 2008/0220331 A1
(43) Pub. Date: Sep. 11, 2008

(54) Nonaqueous electrolyte secondary battery and method of producing the same

(76) Inventors: Hiroshi Minami, Moriguchi-city (JP); Naoki Imachi, Moriguchi-city (JP)

Correspondence Address: KUBOVCIK & KUBOVCIK, SUITE 1105, 1215 SOUTH CLARK STREET, ARLINGTON, VA, 22202, US

(21) Appl. No.: 12/073,404

(22) Filed: Mar. 5, 2008

(30) Foreign Application Priority Data
Mar. 9, 2007 (JP) 2007-060143

(51) Int. Cl. H01M 10/26; H01M 10/04

(52) U.S. Cl. 429/218.1; 29/623.1

(57) ABSTRACT

To obtain a nonaqueous electrolyte secondary battery which has a high capacity and excellent storage characteristics at elevated temperatures. A nonaqueous electrolyte secondary battery having a positive electrode including a positive active material having a layered structure, a negative electrode including a negative active material, and a nonaqueous electrolyte including a lithium electrolyte salt and a solvent, wherein carbon dioxide is dissolved in the nonaqueous electrolyte, and the concentration of the lithium electrolyte salt in the nonaqueous electrolyte is 1.0 mol/liter or more, and the battery is charged in such a way that an end-of-charge potential of the positive electrode becomes 4.40 V (vs. Li/Li⁺) or more.

### BACKGROUND OF THE INVENTION

1. Field of the Invention

The present invention relates to a nonaqueous electrolyte secondary battery and a method of producing the same.

2. Description of the Related Art

In recent years, the downsizing and weight reduction of mobile terminal devices such as a mobile phone, a notebook computer, a PDA and the like moves forward rapidly, and batteries as a drive power source of these mobile terminal devices are required to become a further high capacity. Development of higher capacity of a lithium ion secondary battery having a high energy density among secondary batteries is progressing year after year. Further, in these mobile terminal devices, entertainment functions such as a moving video replay, a game function and the like are increasingly enriched and power consumption tends to increase, and therefore it is strongly desired that the lithium ion battery as a drive power source has a higher capacity and high performance for a prolonged replay or an output improvement.

The conventional developments of a higher capacity lithium ion secondary battery have focused on making members such as a battery case, a separator and a collector (aluminum foil or copper foil) which are not concerned in electrical power generation components thinner and making a density of an active material higher (improvement of the packing density of an electrode). However, these countermeasures are almost approaching the limit and future countermeasures for achieving a higher capacity require essential material changes. However, as for achieving a higher capacity by the active material, in positive active materials, there is little material which has a higher capacity than lithium cobalt oxide and has the same performance or higher than lithium cobalt oxide. On the other hand, in negative active materials, negative electrodes of alloy of Si, Sn or the like are expected.

A theoretical capacity of lithium cobalt oxide is about 273 mAh/g, and just about 160 mAh/g of the theoretical capacity is used when an end-of-charge voltage is 4.2 V. By raising the end-of-charge voltage to 4.4 V, a capacity can be used up to about 200 mAh/g and it is possible to achieve a higher capacity by about 10% as a whole battery. However, when the battery is use data high voltage, the oxidation power of the charged positive active material is increased, and therefore not only the decomposition of the electrolyte solution is accelerated, but also the stability of a crystal structure of the positive active material itself, from which lithium is extracted, is lost, and cycle deterioration or storage deterioration due to the decay of crystal becomes a problem.

In the battery in which the end-of-charge voltage is raised, the stability of a crystal structure of the positive active material is lost as described above. Particularly, the reduction in a battery performance at elevated temperatures becomes remarkable. Though a detailed cause for this is not clear, in accordance with the investigation of the present inventors, it is estimated that a resolvent of the electrolyte solution or elements eluted from the positive active material (when lithium cobalt oxide was used, the elution of cobalt was observed) were observed and these resolvent and elements are main factors for the reduction in storage characteristics in storing a battery at elevated temperatures.

Particularly, in battery systems using a positive active material such as lithium cobalt oxide, lithium manganese oxide or lithium complex oxide of nickel-cobalt-manganese, the precipitation of Co or Mn on a negative electrode or a separator due to the storage deterioration at elevated temperatures has been observed, and these elements eluted as an ion are precipitated on the negative electrode by being reduced, and this causes problems such as an increase in internal resistance and hence a reduction in a capacity. When the end-of-charge voltage of the lithium ion secondary battery is raised, the instability of a crystal structure increases and these phenomena tend to increase even at a temperature near 50° C. where there was previously no problem in a battery system of 4.2 V specification.

For example, in the battery system in which the end-of-charge voltage of 4.4 V is selected, when a storage test is performed at 60° C. for 5 days in a combination of the active materials of lithium cobalt oxide and graphite, a residual capacity is significantly reduced and may be reduced to almost zero. This battery was disassembled, and consequently a large amount of cobalt (Co) was detected from the negative electrode and separator, and therefore it is thought that elements eluted from the positive electrode accelerated a deterioration mode. It is estimated that this deterioration results from that a valence of the positive active material having a layered structure increases by extracting a lithium ion, but a Co ion is apt to elute from a crystal because tetravalent cobalt is unstable and therefore a crystal itself is not stable and tends to change to a stable structure. When a structure of the charged positive active material is unstable like this, particularly, storage deterioration or cycle deterioration at elevated temperatures tends to become remarkable. It has also been proved that the higher the packing density of the positive electrode, the more this tendency occurs. This tendency is an issue to be solved particularly in a battery of high capacity design. It is estimated that the reason why properties of the separator are concerned in the storage deterioration is that substances reduced at the negative electrode are deposited and fill fine multiple pores of the separator.

In the present invention, as described later, carbon dioxide is dissolved in the nonaqueous electrolyte in order to resolve the above-mentioned problems. Dissolving carbon dioxide in the nonaqueous electrolyte is proposed in, for example, U.S. Pat. No. 4,853,304 specification, Japanese Unexamined Patent Publication No. 6-124700, and Japanese Unexamined Patent Publication No. 7-176323. However, in these patents, it is proposed to dissolve carbon dioxide in a nonaqueous electrolyte in a conventional battery in which the end-of-charge voltage is 4.2 V and these patents pertain to forming a coat on the surface of the negative electrode.

Further, in the present invention, as described later, an inorganic particle layer made of alumina, etc. is preferably formed on the surface of the negative electrode as described later, and it is proposed to form a porous insulating layer on the surface of the positive or negative electrode to improve the safety against the insertion of nails in Patent Publication No. 3371301 and International Publication WO 2005/057691A1 pamphlet. Further, in Japanese Unexamined Patent Publication No. 2005-259467, it is proposed that projections and depressions are intentionally formed in a porous layer and thereby an electrolyte solution-absorbing property in a battery is improved. In Japanese Unexamined Patent Publication No. 2005-50779, lithium cobalt oxide containing Zr and Mg which are preferably employed in the present invention is disclosed.

It is an object of the present invention to provide a nonaqueous electrolyte secondary battery which has a high capacity and excellent storage characteristics at elevated temperatures, and a method of producing the same.

### SUMMARY OF THE INVENTION

The present invention pertains to a nonaqueous electrolyte secondary battery having a positive electrode including a positive active material having a layered structure, a negative electrode including a negative active material, and a nonaqueous electrolyte including a lithium electrolyte salt and a solvent, wherein carbon dioxide is dissolved in the nonaqueous electrolyte, and the concentration of the lithium electrolyte salt in the nonaqueous electrolyte is 1.0 mol/liter or more, and the battery is charged in such a way that an end-of-charge potential of the positive electrode becomes 4.40 V (vs. Li/Li⁺) or more.

In the present invention, carbon dioxide is dissolved in the nonaqueous electrolyte, and the battery is charged in such a way that the end-of-charge potential of the positive electrode becomes 4.40 V (vs. Li/Li⁺) or more. It is known that carbon dioxide dissolved in the nonaqueous electrolyte forms a coat derived from carbon dioxide on the surface of the negative electrode, but it is also possible to form a coat derived from carbon dioxide on the surface of the positive electrode associated with a decomposition reaction of the lithium salt by charging the battery in such a way that the end-of-charge potential of the positive electrode becomes 4.40 V (vs. Li/Li⁺) or more. By forming the coat on the surface of the positive active material, a decomposition reaction of the nonaqueous electrolyte or the elution of Co, Mn or the like from the positive active material at a high voltage can be inhibited. Therefore, in accordance with the present invention, the decomposition reaction of the nonaqueous electrolyte or the elution of Co and Mn from the positive active material can be inhibited, and the storage characteristics at elevated temperatures can be improved.

Preferably, an amount of carbon dioxide to be dissolved in the nonaqueous electrolyte is 0.01% by weight or more. When the amount of carbon dioxide to be dissolved in the nonaqueous electrolyte is less than 0.01% by weight, an effect of forming the coat derived from carbon dioxide may not be adequately achieved. An upper limit of the amount of carbon dioxide to be dissolved in the nonaqueous electrolyte is a saturated dissolved amount of carbon dioxide, which varies with a solvent to be used, and this upper limit is 1.0% by weight or less at 25° C. in a common mixed solvent system of cyclic carbonate and chain carbonate.

Further, in the present invention, as described above, the battery is charged in such a way that the end-of-charge potential of the positive electrode becomes 4.40 V (vs. Li/Li⁺) or more. The higher the end-of-charge potential of the positive electrode is, the larger effect of dissolving carbon dioxide in the nonaqueous electrolyte is exhibited. That is, when the end-of-charge potential of the positive electrode is high, reactivity at the positive electrode become high and a decomposition reaction of the lithium electrolyte salt tends to occur. Carbon dioxide in the nonaqueous electrolyte is linked with this decomposition reaction of the lithium electrolyte salt at the positive electrode to form a coat derived from carbon dioxide on the surface of the positive active material. Thus, in the present invention, the end-of-charge potential of the positive electrode is set at 4.40 V (vs. Li/Li⁺) or more. Further, a higher charge-discharge capacity can be achieved by setting the end-of-charge voltage of the positive electrode high. In the present invention, the end-of-charge potential of the positive electrode is furthermore preferably 4.45 V (vs. Li/Li⁺) or more. When a carbon material such as graphite is used as a negative active material, the end-of-charge potential of the negative electrode is about 0.1 V (vs. Li/Li⁺), and therefore the end-of-charge voltage as a battery is 4.30 V in the case where the end-of-charge potential of the positive electrode is 4.40 V (vs. Li/Li⁺).

In the present invention, the concentration of the lithium electrolyte salt in the nonaqueous electrolyte is set at 1.0 mol/liter or more. This concentration has been set considering that as described above, the lithium electrolyte salt is decomposed at the positive electrode when the end-of-charge voltage of the positive electrode is high. The decomposition of the lithium electrolyte salt at the positive electrode causes the conductivity of the nonaqueous electrolyte to reduce and causes the reduction in load characteristics in a battery or the load deterioration of cycle characteristics to occur noticeably. By setting the concentration of the lithium electrolyte salt at 1.0 mol/liter or more according to the present invention, a degree of conductivity can be maintained and the reduction in load characteristics or the load deterioration of cycle characteristics can be inhibited even when the lithium electrolyte salt is decomposed. Further, since the lithium electrolyte salt has an effect of catalytically accelerating a reaction in part in forming the coat derived from carbon dioxide on the surface of the positive electrode, the lithium electrolyte salt can form a more thick coat on the surface of the positive active material as the concentration of the lithium electrolyte salt increases. An upper limit of the concentration of the lithium electrolyte salt is commonly 2.0 mol/liter or less.

Since LiPF₆, which is normally used as a lithium electrolyte salt at the present day, has high solubility in a solvent and high conductivity, while LiPF₆ has high reactivity, there is apprehension that safety is deteriorated when the concentration of LiPF₆ is high. Accordingly, in the present invention, preferably, LiPF₆ and at least one species of lithium electrolyte salt other than LiPF₆ are included. Examples of the lithium electrolyte salt other than LiPF₆ include at least one species selected from the group consisting of LiXF_{y} (wherein X represents an element As, Sb, B, Bi, Al, Ga, or In, and when X is As or Sb, y is an integer of 6, and when X is B, Bi, Al, Ga, or In, y is an integer of 4), lithium(perfluoroalkylsulfonyl)imide LiN(C_{ml F}₂ₘ₊₁SO₂)(CₙF₂ₙ₊₁SO₂) (wherein m and n are each independently an integer of 1 to 4), and lithium(perfluoroalkylsulfonyl)methide LiC(CₚF₂ₚ₊₁SO₂)(C_{q}F_{2q+1}SO₂)(CᵣF₂ᵣ₊₁SO₂) (wherein p, q and r are independent, and an integer of 1 to 4). These lithium electrolyte salts cause a decomposition reaction at the positive electrode and accelerate to form the coat derived from carbon dioxide on the surface of the positive active material at a high voltage as with LiPF₆.

As a solvent of the nonaqueous electrolyte to be used in the present invention, a substance which is hitherto used as a solvent for an electrolyte of a lithium secondary battery can be used. Among others, a mixed solvent of cyclic carbonate and chain carbonate is particularly preferably used. The saturated dissolved amount of carbon dioxide in chain carbonate is larger than that in cyclic carbonate. Therefore, it is preferable that the proportion of the chain carbonate is higher than that of the cyclic carbonate. However, only chain carbonate is used as a solvent, the reduction in storage characteristics at elevated temperatures or in cycle characteristics becomes noticeable. Therefore, it is preferable to use a solvent composition including much carbon dioxide in the nonaqueous electrolyte without reducing battery performance. Specifically, it is preferable that a mixing ratio between the cyclic carbonate and the chain carbonate (cyclic carbonate: chain carbonate) is in the rage of 1:9 to 5:5.

Examples of the cyclic carbonates include ethylene carbonate, propylene carbonate, butylene carbonate, and vinylene carbonate. Examples of the chain carbonates include dimethyl carbonate, methyl ethyl carbonate, and diethyl carbonate.

In the present invention, preferably, a ratio (negative electrode charge capacity/positive electrode charge capacity) of a charge capacity of the negative electrode to a charge capacity of the positive electrode is in a range of 1.0 to 1.1. By setting the ratio between charge capacities of the negative electrode and the positive electrode at 1.0 or more, the deposition of metal lithium on the surface of the negative electrode can be prevented. Therefore, the cycle characteristics and the safety of the battery can be enhanced. Further, when the ratio between charge capacities of the negative electrode and the positive electrode is more than 1.1, it maybe unfavorable since an energy density per volume is reduced. In addition, such a ratio between charge capacities of the negative electrode and the positive electrode is set in response to an end-of-charge voltage of a battery.

In the present invention, preferably, an inorganic particle layer including an inorganic particle which does not occlude and release lithium and a binder is placed on the surface of the negative electrode. By forming such an inorganic particle layer on the surface of the negative electrode, a binder component contained in the inorganic particle layer absorbs the nonaqueous electrolyte to swell and thereby a layer having a moderate filtrating function is formed between the negative electrode and the separator. This filtrating layer traps resolvent formed by a reaction of the nonaqueous electrolyte at the positive electrode, or elements (for example, cobalt ion, manganese ion, etc.) eluted from the positive active material to prevent these substances from depositing on the surface of the negative electrode or on the separator. Thereby, it is possible to mitigate damages to the negative electrode or the separator to limit the storage deterioration at elevated temperatures. However, since the inorganic particle layer itself does not inhibit the decomposition or the elution at the positive electrode, it is difficult to inhibit completely plugging of the separator due to the resolvent or the eluted substance. Therefore, in the present invention, by forming a coat on the surface of the positive electrode with carbon dioxide, an amount of the resolvent or the eluted substance from the positive electrode is reduced and the storage characteristics or the cycle characteristics at elevated temperatures is improved.

Further, by covering the negative active material with the binder contained in the inorganic particle layer at the surface of the negative electrode, a reaction of formation of the coat derived from carbon dioxide, which is formed on the surface of the negative active material, can be inhibited and therefore the consumption of carbon dioxide in the nonaqueous electrolyte can be reduced compared with the case where the inorganic particle layer is not placed on the surface of the negative electrode. Accordingly, the concentration of carbon dioxide linked with the formation of a coat on the surface of the positive electrode is increased, and therefore a thick coat can be formed on the surface of the positive electrode and the storage characteristics and the cycle characteristics at elevated temperatures can be improved.

As inorganic particles used for forming the inorganic particle layer, rutile type titanium oxide (rutile type titania), aluminum oxide (alumina), zirconium oxide (zirconia) and magnesium oxide (magnesia) can be used. An average particle diameter is preferably 1 μm or less, and furthermore preferably in a range of 0.1 to 0.8 μm. In consideration of the dispersibility in slurry, the inorganic particle, the surface of which is surface treated with Al, Si or Ti, is particularly preferable. An average particle diameter of the inorganic particle is preferably larger than an average pore size of the separator. By selecting the average particle diameter larger than the average pore size of the separator, the damages to the separator can be mitigated and the intrusion of the inorganic particle into fine multiple pores of the separator can be inhibited. In consideration of safety (i.e., reactivity with lithium) in the battery or cost, aluminum oxide and rutile type titanium oxide are particularly preferable.

A thickness of the inorganic particle layer is preferably in a range of 0.5 to 4 μm, and particularly preferably in a range of 0.5 to 2 μm. If the thickness of the inorganic particle layer is too small, an effect achieved by forming the inorganic particle layer may become inadequate, and if the thickness of the inorganic particle layer is too large, load characteristics of the battery may reduce, or an energy density of the battery may be reduced.

A binder in the inorganic particle layer is not particularly limited in its material, but a material comprehensively satisfying characteristics such as (1) securing the dispersibility of the inorganic particle (prevention of reflocculating), (2) securing the adhesion to withstand a production process of a battery, (3) filling the gaps between the inorganic particles produced due to swelling after absorbing a nonaqueous electrolyte, and (4) low elution of a nonaqueous electrolyte is preferable. In order to secure battery performance, it is preferable to exert these characteristics in a small amount of the binder. Accordingly, the content of the binder in the inorganic particle layer is preferably 30 parts by weight or less with respect to 100 parts by weight of the inorganic particle, more preferably 10 parts by weight or less, and furthermore preferably 5 parts by weight or less. A lower limit of an amount of the binder in the inorganic particle layer is commonly 0.1 part by weight or more. As a material of the binder, polytetrafluoroethylene (PTFE), polyvinylidene fluoride (PVDF), polyacrylonitrile (PAN), styrene-butadiene rubber (SBR), modified substances and derivatives thereof, copolymers including an acrylonitrile unit, polyacrylic acid derivatives and the like are preferably used. Particularly when the above-mentioned characteristics (1) to (3) are highly regarded and met with a small amount of the binder material to be added, copolymers including an acrylonitrile unit are preferably employed.

As a solvent used in preparing slurry for forming the inorganic particle layer, N-methyl pyrrolidone (NMP), cyclohexanone, water, or the like can be used besides acetone, but the solvent is not limited to these. As for a method of dispersing slurry, wet dispersion methods such as FILMICS manufactured by Tokushu Kika Kogyo Co., Ltd., and a bead mill type are suitable. Dispersion methods used for dispersion of a coating material are preferably used particularly because a particle size of the inorganic particle used in the present invention is small, and settling of slurry is intense and a uniform film cannot be formed if the slurry is not mechanically dispersed.

Examples of a method of forming the inorganic particle layer on the negative electrode include a die coating method, a gravure coating method, a dip coating method, a curtain coating method, a spray coating method, and the like. Particularly, the gravure coating method and the die coating method are preferably employed. Further, in consideration of the reduction in adhesive strength due to the diffusion of a solvent or a binder into the electrode, a method, in which the slurry can be applied quickly and the solvent is evaporated in short time, is desirable. The concentration of solid matter in the slurry varies greatly depending on a coating method. In the case of the spray coating method, the dip coating method or the curtain coating method in which a thickness of the layer cannot be mechanically controlled, it is preferable that the concentration of solid matter is low and is in a range of 3 to 30% by weight. In addition, in the case of the die coating method or the gravure coating method, the concentration of solid matter may be high or may be low, and is preferably about 5 to 70% by weight.

The positive active material to be used in the present invention has a layered structure. Particularly, lithium-containing transition metal oxide having a layered structure is preferably employed. Examples of the lithium transition metal oxide include lithium complex oxides containing cobalt or manganese such as lithium cobalt oxide, lithium complex oxide of cobalt-nickel-manganese, lithium complex oxide of aluminum-nickel-manganese and lithium complex oxide of aluminum-nickel-cobalt. Particularly, a positive active material, in which a capacity is increased by setting the end-of-charge potential of the positive electrode at 4.40 V (vs. Li/Li⁺) or more, is preferably used. The positive active materials may be used singly or as a mixture with another positive active material.

It is known that lithium cobalt oxide has a crystal structure which becomes instable as charge depth is enhanced. Therefore, when lithium cobalt oxide is used, it is preferable to add Zr and Mg to the lithium cobalt oxide in advance. By adding Zr and Mg, stable charge-discharge cycle characteristics can be attained. An amount of Zr to be added is preferably in a range of 0.01 to 3 mol % of the total amount of metal elements other than lithium in lithium cobalt oxide. An amount of Mg to be added is preferably in a range of 0.01 to 3 mol % of the total amount of metal elements other than lithium in lithium cobalt oxide. It is preferable to include Zr with Zr adhering to the surface of lithium cobalt oxide in the form of a particle as disclosed in Japanese Unexamined Patent Publication No. 2005-50779. By adding Zr and Mg within these ranges, stable charge-discharge cycle characteristics can be attained.

Further, when lithium cobalt oxide is used at a high end-of-charge potential, a capacity increases but thermal stability is deteriorated. By adding Al to lithium cobalt oxide, thermal stability can be enhanced. Preferably, an amount of Al to be added is in a range of 0.01 to 3 mol % of the total amount of metal elements other than lithium in lithium cobalt oxide.

Accordingly, it is preferable to add Zr, Mg and Al to lithium cobalt oxide to be used in the present invention.

The negative active material used in the present invention is not particularly limited, and a substance which can be used as a negative active material of the nonaqueous electrolyte secondary battery can be used. Examples of the negative active material include carbon materials such as graphite, cokes and the like, metal oxides such as tin oxide and the like, metals, which can occlude lithium by being alloyed with lithium, such as silicon, tin and the like, and metal lithium. As the negative active material in the present invention, particularly, carbon materials such as graphite and the like are preferably employed.

A production method of the present invention is a method by which the above-mentioned nonaqueous electrolyte secondary battery of the present invention can be produced, and it is characterized by including the steps of dissolving carbon dioxide in the nonaqueous electrolyte, and assembling the nonaqueous electrolyte secondary battery by use of the nonaqueous electrolyte in which carbon dioxide is dissolved, the positive electrode and the negative electrode. Examples of the method of dissolving carbon dioxide in the nonaqueous electrolyte include a method of injecting gaseous carbon dioxide into the nonaqueous electrolyte and a method of shaking the nonaqueous electrolyte in an atmosphere of carbon dioxide.

The step of assembling the nonaqueous electrolyte secondary battery is preferably performed in an inert atmosphere, and more preferably performed in an inert atmosphere including carbon dioxide. Since carbon dioxide dissolved in the nonaqueous electrolyte is consumed for forming a coat on the surface of the negative electrode, the concentration of carbon dioxide in the nonaqueous electrolyte is decreased. All of carbon dioxide in the nonaqueous electrolyte is not used for the formation of a coat on the surface of the negative electrode, but an amount of carbon dioxide to be used for the subsequent formation of a coat on the surface of the positive active material is reduced, and therefore it becomes difficult to form a thick coat on the surface of the positive electrode if carbon dioxide in the nonaqueous electrolyte is consumed for the formation of a coat on the surface of the negative electrode. Therefore, by assembling the nonaqueous electrolyte secondary battery in an atmosphere including carbon dioxide in order to supplement the carbon dioxide consumed for forming a coat on the surface of the negative electrode, it is possible to newly supply carbon dioxide to the nonaqueous electrolyte during an assembling process and enhance the concentration of the carbon dioxide in the nonaqueous electrolyte. Thereby, it becomes possible to form a thick coat on the surface of the positive electrode.

In the present invention, carbon dioxide is dissolved in the nonaqueous electrolyte and the coat derived from carbon dioxide is formed to cover the surface of the positive active material at a high voltage. Accordingly, since the positive active material does not contact directly with the nonaqueous electrolyte, the decomposition reaction of the nonaqueous electrolyte can be inhibited and the elution of transition metals such as Co or Mn from the positive active material can be inhibited. Therefore, storage characteristics at elevated temperatures can be improved and cycle characteristics can be enhanced.

Further, since the concentration of the lithium electrolyte salt is 1.0 mol/liter or more, are action of formation of the coat derived from carbon dioxide tends to occur and therefore a thick coat can be formed on the surface of the positive active material.

In accordance with the production method of the present invention, it is possible to fabricate a nonaqueous electrolyte secondary battery which has excellent storage characteristics at elevated temperatures and excellent cycle characteristics by dissolving carbon dioxide in the nonaqueous electrolyte.

### DETAILED DESCRIPTION OF THE PREFERRED EMBODIMENT

Hereinafter, the present invention will be described in more detail, but the present invention is not limited to the following embodiments, and variations may be appropriately made without changing the gist of the present invention. In Examples and Comparative Examples described later, a positive electrode, a negative electrode, an inorganic particle layer, and a nonaqueous electrolyte solution were prepared and a nonaqueous electrolyte secondary battery was assembled according to the following procedures.

### [Preparation of Positive Electrode]

A positive active material, acetylene black which is a carbon-conductive material, and polyvinylidene fluoride (PVDF) were mixed so as to be a mass ratio of 95:2.5:2.5, and the resulting mixture was stirred in N-methyl pyrrolidone (NMP) as a solvent with a kneader to prepare slurry for forming a positive electrode. This slurry was applied onto both sides of aluminum foil, and dried, and the aluminum foil coated with the slurry was rolled to form an electrode.

### [Preparation of Negative Electrode}

Graphite, sodium carboxymethyl cellulose (CMC) and styrene-butadiene rubber (SBR) were mixed in an aqueous solution so as to be a mass ratio of 98:1:1, and the resulting mixture was applied onto both sides of copper foil which is a collector, and then dried, and the copper foil coated with the mixture was rolled to form an electrode. A packing density of the negative active material was set at 1.60 g/ml.

### [Preparation of Inorganic Particle Layer]

Using acetone as a solvent, titanium oxide (rutile type, average particle diameter 0.38 μm, “KR 380” produced by Titan Kogyo, Co., Ltd.) was mixed in the solvent in such a way that the concentration of solid matter was 20% by weight, and in the resulting mixture, a copolymer (rubber-like polymer) including an acrylonitrile structure (unit) was mixed in such a way that the content of the copolymer was 2.5 parts by weight with respect to 100 parts by weight of titanium oxide. The resulting mixture was mixed/dispersed with a bead mill type kneader to prepare slurry in which titanium oxide is dispersed. This slurry was applied onto the surface of the negative electrode by a gravure coating process and the solvent was evaporated to be removed to form an inorganic particle layer on the surface of the negative electrode.

### [Preparation of Nonaqueous Electrolyte Solution]

As an electrolyte solution, a solution, which was prepared by dissolving LiPF₆ in a mixture solvent formed by mixing ethylene carbonate (EC) and diethyl carbonate (DEC) in proportions of 3:7 by volume in such a way that the concentration of LiPF₆ as a main component in the solvent was 1 mol/liter, was used. Further, a solution prepared by dissolving carbon dioxide in the electrolyte solution was used as required. In addition, a lithium electrolyte salt other than LiPF₆ was added in a prescribed concentration as required.

### [Assembly of Battery]

A lead terminal was attached to each of the positive and negative electrodes, and the positive electrode, the negative electrode, and a separator were rolled in a spiral fashion with the separator interposed therebetween. This rolled article was pressed to prepare an electrode body flattened out. This electrode body was put in a battery case of aluminum-laminate, and an electrolyte solution was poured in the case, and the battery case was sealed to fabricate a secondary battery. Incidentally, a design capacity of the battery is 780 mAh. Further, the design capacity of the battery was determined based on an end-of-charge voltage of from 4.2 to 4.4 V.

In Examples and Comparative Examples described later, each battery was evaluated according to the following procedures.

### <Evaluation of Battery>

### [Charge-Discharge Test]

A constant current charge was performed at 1 C (750 mA) of current until a voltage reached 4.2 V (or up to 4.4 V (changed to suit design)), and a charge was performed at a constant voltage of 4.2 V (or up to 4.4 V (changed to suit design)) until a current reached 0.05 C (37.5 mA).

Further, a constant current discharge was performed at 1 C (750 mA) of current until a voltage reached 2.75 V.

An interval between the charge and the discharge was set at 10 minutes.

### [Storage Test at 60° C.]

A battery, which had been charged to a set voltage again by performing a charge-discharge cycle once under the above-mentioned condition of 1 C rate in accordance with design, was left standing at 60° C. for 5 days. Thereafter, the battery was cooled to room temperature, and a discharge was performed at 1 C of current, and then the charge-discharge cycle test was performed again at 1 C of current. From a discharge capacity before the storage test and the first discharge capacity after the storage test, a residual ratio of the discharge capacity was calculated by the following equation.

Residual ratio (%)=(the first discharge capacity after storage test/discharge capacity before storage test)×100

### EXAMPLE 1

### Battery T1

Using lithium cobalt oxide as a positive active material and artificial graphite as a negative active material, a positive electrode and a negative electrode were fabricated by the method described above. Lithium cobalt oxide containing Al and Mg in an amount 1 mol %, respectively, and Zr in an amount 0.05 mol % was used as the above lithium cobalt oxide. Incidentally, Zr adhered to the surface of lithium cobalt oxide in the form of a particle.

A battery was designed in such a way that the end-of-charge voltage becomes 4.30 V (4.40 V (vs. Li/Li⁺) as the end-of-charge potential of the positive electrode), and was designed at this potential in such a way that a ratio between charge capacities of the negative and positive electrodes (the first negative electrode charge capacity/the first positive electrode charge capacity) becomes 1.08. A packing density of the positive electrode was set at 3.60 g/ml. As the electrolyte solution, an electrolyte formed by using LiPF₆ of 1 mol/liter as a lithium electrolyte salt and dissolving carbon dioxide in this LiPF₆ was used. An amount of carbon dioxide dissolved was 0.48% by weight at 25° C. This battery was taken as a battery T1 of the present invention.

### EXAMPLE 2

### Battery T2

A battery was prepared in the same manner as in Example 1 except for designing the battery in such a way that the end-of-charge voltage becomes 4.40 V (4.50 V (vs. Li/Li⁺) as the end-of-charge potential of the positive electrode), and designing in such a way that a ratio between capacities of the negative electrode and the positive electrode (the first negative electrode charge capacity/the first positive electrode charge capacity) becomes 1.08 at this potential. This battery was taken as a battery T2 of the present invention.

### EXAMPLE 3

### Battery T3

A battery was prepared in the same manner as in Example 2 except for dissolving LiPF₆ of 1.2 mol/liter in the electrolyte solution. This battery was taken as a battery T3 of the present invention.

### EXAMPLE 4

### Battery T4

An inorganic particle layer was formed on the surface of the negative electrode. This inorganic particle layer was formed by diluting titanium oxide (rutile type) with acetone in such a way that the concentration of solid matter was 20% by weight (the content of the binder was 2.5 parts by weight with respect to 100 parts by weight of titanium oxide) to prepare slurry, and applying this slurry onto the negative electrode. The inorganic particle layer was formed so as to be 2 μm in a thickness per a side and 4 μm in a thickness per both sides. A battery was prepared in the same manner as in Example 2 except for using this negative electrode. This battery was taken as a battery T4 of the present invention.

### EXAMPLE 5

### Battery T5

A battery was prepared in the same manner as in Example 2 except for dissolving LiPF₆ of 1.0 mol/liter and LiBF₄ of 0.2 mol/liter in the electrolyte solution. This battery was taken as a battery T5 of the present invention.

### EXAMPLE 6

### Battery T6

A battery was prepared in the same manner as in Example 2 except for dissolving LiPF₆ of 1.0 mol/liter and LiN(CF₃SO₂)₂(LiTFSI) of 0.2 mol/liter in the electrolyte solution. This battery was taken as a battery T6 of the present invention.

### COMPARATIVE EXAMPLE 1

### Battery R1

A battery was prepared in the same manner as in Example 1 except for designing the battery in such a way that the end-of-charge voltage becomes 4.20 V (4.30 V (vs. Li/Li⁺) as the end-of-charge potential of the positive electrode), and designing in such a way that a ratio between capacities of the negative electrode and the positive electrode (the first negative electrode charge capacity/the first positive electrode charge capacity) becomes 1.08 at this potential. This battery was taken as a battery R1 for comparison.

### COMPARATIVE EXAMPLE 2

### Battery R2

A battery was prepared in the same manner as in Comparative Example 1 except for not dissolving CO₂ in the electrolyte solution. This battery was taken as a battery R2 for comparison.

### COMPARATIVE EXAMPLE 3

### Battery R3

A battery was prepared in the same manner as in Example 1 except for not dissolving CO₂ in the electrolyte solution. This battery was taken as a battery R3 for comparison.

### COMPARATIVE EXAMPLE 4

### Battery R4

A battery was prepared in the same manner as in Example 2 except for not dissolving CO₂ in the electrolyte solution. This battery was taken as a battery R4 for comparison.

### COMPARATIVE EXAMPLE 5

### Battery R5

A battery was prepared in the same manner as in Example 2 except for dissolving LiPF₆ of 0.8 mol/liter in the electrolyte solution. This battery was taken as a battery R5 for comparison.

### COMPARATIVE EXAMPLE 6

### Battery R6

A battery was prepared in the same manner as in Comparative Example 4 except for dissolving LiPF₆ of 1.2 mol/liter in the electrolyte solution. This battery was taken as a battery R6 for comparison.

### COMPARATIVE EXAMPLE 7

### Battery 7

A battery was prepared in the same manner as in Comparative Example 4 except for using the negative electrode used in Example 4. This battery was taken as a battery R7 for comparison.

In addition, in the above-mentioned batteries, a battery of T series represents a battery of Examples according to the present invention and a battery of R series represents a battery of Comparative Examples.

### <Investigation of End-of-Charge Potential of Positive Electrode>

The species and concentration of the lithium electrolyte salt were set to LiPF₆ of 1.0 mol/liter, and the effects on the storage characteristics in changing the end-of-charge potential of the positive electrode from 4.3 V to 4.5 V were summarized in Table 1.

TABLE 1

| End-of-Charge | Dissolving CO₂ | | | Without Dissolving CO₂ | | |
|---|---|---|---|---|---|---|
| Potential | | Residual | Coloring of | | Residual | Coloring of |
| (vs. Li/Li⁺) | Battery | Ratio (%) | Separator | Battery | Ratio (%) | Separator |
| 4.3 V | R1 | 88.8 | Colorless | R2 | 88.3 | Colorless |
| 4.4 V | T1 | 82.3 | Colorless | R3 | 66.9 | Colored |
| | | | | | | Somewhat |
| 4.5 V | T2 | 61.2 | Slightly | R4 | 20.1 | Colored |
| | | | Colored | | | |

As is apparent from the results shown in Table 1, it is found that by dissolving carbon dioxide in the electrolyte solution in setting the end-of-charge potential of the positive electrode at 4.4 V (vs. Li/Li⁺) or more, a residual ratio is improved and storage characteristics is improved. It is apparent that this action is hardly shown when the end-of-charge potential of the positive electrode is 4.3 V (vs. Li/Li⁺), and a larger action is shown as the end-of-charge potential increases when the end-of-charge potential of the positive electrode is 4.4 V (vs. Li/Li⁺) or more.

In the state of charge at elevated temperature, reactivity at the positive electrode is high, and therefore the decomposition of the lithium electrolyte salt occurs and the coat derived from carbon dioxide is formed on the surface of the positive electrode. It is estimated that by virtue of this coat, the positive active material does not contact directly with the electrolyte solution and the decomposition of the electrolyte solution and the elution of Co or the like in the positive active material can be inhibited.

The battery in the state of discharge after the storage test was disassembled and a degree of coloring of the separator was observed, and consequently it was found that the coloring of a separator was inhibited by dissolving carbon dioxide in the electrolyte solution as shown in Table 1. This result indicates that plugging of the separator due to the resolvent or the eluted substance from the positive electrode side is inhibited, and it is thought that by forming a coat on the surface of the positive electrode, an amount of the resolvent or the eluted substance from the positive electrode was reduced.

### <Investigation of Concentration of Lithium Electrolyte Salt>

The end-of-charge potential of the positive electrode was set to 4.50 V (vs. Li/Li⁺), and the concentration of the lithium electrolyte salt was changed and the effects of this change on storage characteristics were investigated. The results are shown in Table 2.

TABLE 2

| | Dissolving CO₂ | | | Without Dissolving CO₂ | | |
|---|---|---|---|---|---|---|
| Concentration | | Residual | Coloring of | | Residual | Coloring of |
| of Lithium Salt | Battery | Ratio (%) | Separator | Battery | Ratio (%) | Separator |
| 0.8M | R5 | 24.1 | Colored | — | — | — |
| | | | Somewhat | | | |
| 1.0M | T2 | 61.2 | Slightly | R4 | 20.1 | Colored |
| | | | Colored | | | |
| 1.2M | T3 | 69.5 | Colorless | R6 | 21.3 | Colored |

From the results shown in Table 2, it is apparent that when carbon dioxide is dissolved in the electrolyte solution, a residual ratio is greatly improved and storage characteristics is improved in the case where the concentration of the lithium electrolyte salt is 1.0 mol/liter or more. Further, it is apparent that coloring of a separator after disassembling the battery is also inhibited as the concentration of the lithium electrolyte salt increases. The reason for this is thought that when the concentration of the lithium electrolyte salt is high, a thick coat was formed on the surface of the positive electrode and therefore the decomposition of the electrolyte solution at the positive electrode or the elution of Co or the like from the positive active material could be inhibited. Its effect is greatly shown particularly when the concentration of the lithium electrolyte salt is 1.0 mol/liter or more. It is found that even though the concentration of the lithium electrolyte salt is high, there is little effect of the concentration of the lithium electrolyte salt and little effect of inhibiting the decomposition and the elution if carbon dioxide is not dissolved in the electrolyte solution. Also in the case where the lithium electrolyte salt is decomposed at the positive electrode, the coat is not formed on the surface of the positive electrode and therefore an effect of improving storage characteristics is hardly obtained if carbon dioxide is not dissolved in the electrolyte solution. Accordingly, it is understood that the coat is not formed on the surface of the positive electrode through only the decomposition of the lithium electrolyte salt and carbon dioxide is linked with the formation of a coat on the surface of the positive electrode.

### <Investigation of Inorganic Particle Layer>

The end-of-charge potential of the positive electrode was set to 4.50 V (vs. Li/Li⁺) and the concentration of LiPF₆ being a lithium electrolyte salt was fixed to 1.0 mol/liter, and the effect of an inorganic particle layer formed on the surface of the negative electrode on storage characteristics was investigated. The results are shown in Table 3.

TABLE 3

| | Dissolving CO₂ | | | Without Dissolving CO₂ | | |
|---|---|---|---|---|---|---|
| Inorganic | | Residual | Coloring of | | Residual | Coloring of |
| Particle Layer | Battery | Ratio (%) | Separator | Battery | Ratio (%) | Separator |
| Present | T4 | 81.5 | Colorless | R7 | 64.3 | Colored |
| | | | | | | Somewhat |
| None | T2 | 61.2 | Slightly | R4 | 20.1 | Colored |
| | | | Colored | | | |

From the results shown in Table 3, it is recognized that a residual ratio is improved by placing the inorganic particle layer on the surface of the negative electrode and further the storage characteristic is improved by dissolving carbon dioxide in the electrolyte solution. By placing the inorganic particle layer on the surface of the negative electrode, it is possible to trap the resolvent formed by a reaction of the electrolyte solution at the positive electrode, or cobalt or the like eluted from the positive active material to inhibit these substances from depositing on the surface of the negative electrode or on the separator. However, since the inorganic particle layer itself does not have an effect of inhibiting the decomposition or the elution at the positive electrode, it is difficult to inhibit completely plugging of the separator, and coloring is found a little in a separator obtained by disassembling and drying the battery after storage. When carbon dioxide is dissolved in the electrolyte solution, a coat is formed on the surface of the positive electrode and the decomposition of the electrolyte solution at the positive electrode or the elution reaction from the positive active material can be inhibited. Thereby, the coloring of the separator can be reduced. Further, when the inorganic particle layer is placed on the surface of the negative electrode, since the binder contained in the inorganic particle layer covers the surface of the negative electrode, coat formation of carbon dioxide on the surface of the negative electrode is inhibited. Therefore, an amount of carbon dioxide consumed on the negative electrode side is reduced, and an amount of carbon dioxide capable of being linked with the formation of a coat on the surface of the positive electrode is increased, and therefore a thick coat can be formed on the surface of the positive electrode. Thereby, the decomposition at the positive electrode or the elution reaction can be further inhibited, and the storage characteristics can be further improved.

### <Investigation of Species of Lithium Electrolyte Salt>

The end-of-charge potential of the positive electrode was set to 4.5 V (vs. Li/Li⁺), and the effect of mixing LiPF₆ with another lithium salt (LiBF₄ or LiTFSI) on storage characteristics was investigated. The results are shown in Table 4.

TABLE 4

| | | Residual | Coloring of |
|---|---|---|---|
| Lithium Salt | Battery | Ratio (%) | Separator |
| LiPF₆(1.0M) + LiBF₄(0.2M) | T5 | 71.0 | Colorless |
| LiPF₆(1.0M) + LiTFSI(0.2M) | T6 | 69.1 | Colorless |
| LiPF₆(1.2M) | T3 | 69.5 | Colorless |

From the results shown in Table 4, it is apparent that when the concentration of the lithium electrolyte salt was set to 1.2 mol/liter and LiPF₆ is mixed with LiBF₄ or LiTFSI, a residual ratio retains a high value and coloring of a separator after disassembling the battery is inhibited as with the case of using LiPF₆ singly. Accordingly, it is understood that if a lithium electrolyte salt which is decomposed at the positive electrode at a high voltage is used, the lithium electrolyte salt can accelerate the formation of a coat of carbon dioxide, and can inhibit the decomposition of the electrolyte solution at the positive electrode or the elution of Co or the like as with LiPF₆.

When LiPF₆ is used singly in a high concentration, it has concluded in a thermal test and the like that safety is deteriorated. This result is due to increasing reactivity of LiPF₆ at elevated temperatures. Therefore, it is possible to significantly improve the storage characteristics while securing safety by mixing LiPF₆ with a lithium salt having lower reactivity to use the resulting mixture.

What is claimed is:

1. A nonaqueous electrolyte secondary battery comprising a positive electrode including a positive active material having a layered structure, a negative electrode including a negative active material, and a nonaqueous electrolyte including a lithium electrolyte salt and a solvent,
wherein carbon dioxide is dissolved in said nonaqueous electrolyte, and the concentration of the lithium electrolyte salt in said nonaqueous electrolyte is 1.0 mol/liter or more, and charge is performed in such a way that an end-of-charge potential of the positive electrode becomes 4.40 V (vs. Li/Li⁺) or more.

2. The nonaqueous electrolyte secondary battery according to claim 1, wherein carbon dioxide is dissolved in an amount 0.01% by weight or more in said nonaqueous electrolyte.

3. The nonaqueous electrolyte secondary battery according to claim 1, wherein a ratio (negative electrode charge capacity/positive electrode charge capacity) of a charge capacity of said negative electrode to a charge capacity of said positive electrode is in a range of 1.0 to 1.1.

4. The nonaqueous electrolyte secondary battery according to claim 1, wherein an inorganic particle layer including an inorganic particle which does not occlude and release lithium and a binder is placed on the surface of said negative electrode.

5. The nonaqueous electrolyte secondary battery according to claim 4, wherein said inorganic particle is rutile type titanium oxide or aluminum oxide.

6. The nonaqueous electrolyte secondary battery according to claim 4, wherein said binder in said inorganic particle layer is contained in an amount of 30 parts by weight or less with respect to 100 parts by weight of said inorganic particle.

7. The nonaqueous electrolyte secondary battery according to claim 1, wherein LiPF₆ and at least one species of lithium electrolyte salt other than LiPF₆ are included as said lithium electrolyte salt.

8. The nonaqueous electrolyte secondary battery according to claim 7, wherein the lithium electrolyte salt other than LiPF₆ is at least one species selected from the group consisting of LiXF_{y}, wherein X represents an element As, Sb, B, Bi, Al, Ga, or In, and when X is As or Sb, y is an integer of 6, and when X is B, Bi, Al, Ga, or In, y is an integer of 4, lithium(perfluoroalkylsulfonyl)imide LiN(CₘF₂ₘ₊₁SO₂)(CₙF₂ₙ₊₁SO₂), wherein m and n are each independently an integer of 1 to 4, and lithium(perfluoroalkylsulfonyl)methide LiC(CₚF₂ₚ₊₁SO₂)(C_{q}F_{2q+1}SO₂)(CᵣF₂ᵣ₊₁SO₂), wherein p, q and r are each independently an integer of 1 to 4.

9. The nonaqueous electrolyte secondary battery according to claim 1, wherein the end-of-charge potential of said positive electrode is 4.45 V (vs. Li/Li⁺) or more.

10. The nonaqueous electrolyte secondary battery according to claim 1, wherein said positive active material is lithium-containing transition metal oxide.

11. A method of producing the nonaqueous electrolyte secondary battery according to claim 1, comprising the steps of
dissolving carbon dioxide in said nonaqueous electrolyte, and
assembling said nonaqueous electrolyte secondary battery by use of said nonaqueous electrolyte in which carbon dioxide is dissolved, said positive electrode and said negative electrode.

12. The method of producing the nonaqueous electrolyte secondary battery according to claim 11, wherein carbon dioxide is dissolved in said nonaqueous electrolyte by injecting gaseous carbon dioxide into said nonaqueous electrolyte.

13. The method of producing the nonaqueous electrolyte secondary battery according to claim 11, wherein said nonaqueous electrolyte secondary battery is assembled in an atmosphere including carbon dioxide.

14. The nonaqueous electrolyte secondary battery according to claim 2, wherein a ratio (negative electrode charge capacity/positive electrode charge capacity) of a charge capacity of said negative electrode to a charge capacity of said positive electrode is in a range of 1.0 to 1.1.

15. The nonaqueous electrolyte secondary battery according to claim 2, wherein an inorganic particle layer including an inorganic particle which does not occlude and release lithium and a binder is placed on the surface of said negative electrode.

16. The nonaqueous electrolyte secondary battery according to claim 5, wherein said binder in said inorganic particle layer is contained in an amount of 30 parts by weight or less with respect to 100 parts by weight of said inorganic particle.

17. The nonaqueous electrolyte secondary battery according to claim 2, wherein LiPF₆ and at least one species of lithium electrolyte salt other than LiPF₆ are included as said lithium electrolyte salt.

18. The nonaqueous electrolyte secondary battery according to claim 2, wherein the end-of-charge potential of said positive electrode is 4.45 V (vs. Li/Li⁺) or more.

19. The nonaqueous electrolyte secondary battery according to claim 2, wherein said positive active material is lithium-containing transition metal oxide.

20. The method of producing the nonaqueous electrolyte secondary battery according to claim 12, wherein said nonaqueous electrolyte secondary battery is assembled in an atmosphere including carbon dioxide.
